(19) United States
(12) Patent Application Publication
(10) Pub. No.: US 2008/0145819 A1
(43) Pub. Date: Jun. 19, 2008

(54) Screw-in Enossal Dental Implant

(76) Inventor: Robert Boettcher, Ohrdruf (DE)

Correspondence Address: JORDAN AND HAMBURG LLP, 122 EAST 42ND STREET, SUITE 4000, NEW YORK, NY, 10168, US

(21) Appl. No.: 11/884,428

(22) PCT Filed: Aug. 18, 2004
(86) PCT No.: PCT/DE2004/001834

§ 371 Date: Jan. 10, 2008

(51) Int. Cl. A61C 8/00

(52) U.S. Cl. 433/174

(57) ABSTRACT

A screw-in enossal dental implant comprising a base body with a thread arrangement which can be multiple-threaded, and notches, in addition to an upper part and a bulged enossal part. The thread arrangement on the base body is defined by parabolic curves forming intersection points outside the area of the dental implant. The thread arrangement extends as far as the upper part. The flank angle of the thread flanks is 20 DEG. The transition between the base body and the bulged enossal part is rounded. The maximum depth of the notches is ⅓ of the diameter of the base body and the width thereof is at least as large as the width of the respectively remaining thread arrangement between the notches. The dental implant causes the compression forces acting upon the jaw bone to tend unevenly towards zero as the screw-in depth increases, enabling reliable fastening in the enossal area.

### BACKGROUND OF THE INVENTION

The invention relates to a screw-in enossal dental implant having a parabolic base body that has a self-cutting thread arrangement that is provided with at least two notches and that can also be multi-threaded and that has a parabolic thread base, and having an upper part provided coronal to the thread arrangement with a shaped hole to assist with screwing in and a thread for attaching and fixing tooth crowns, bridges, and the like, and having a bulged enossal part and where necessary a cone part and/or a cap.

Screw-in dental implants, including those with a self-cutting thread, have been known for a long time in a variety of embodiments.

Thus for instance known from patent DE 3735378 C2 is a dental implant having an anchoring apparatus that comprises a longitudinally extended cylindrical base body, the thread of which runs slightly conically in the lower part. In this case an opening that runs outward is provided into which bone tissue can grow after the implant has been set, which leads to better bonding strength. Inserted in the upper part of the implant is a bore that is provided with a female thread so that different adapters can be received such as for instance crowns provided with a thread, screws, or tooth prostheses that can be cemented in. Moreover a beveled wall surface is provided that runs into a shaped hole for a screwing tool.

Moreover, known from DE 200 22 420 U1 and DE 200 04 526 U1 are conical implants with cutting edges that at their coronal ends have a larger diameter that remains the same across a longer area than in their apical ends. A self-cutting thread is used that is interrupted by a groove at least at one area so that a cutting edge is formed. Connected in the coronal direction via the cylindrical thread segment is a connecting segment that has positive-fit elements for holding a cap with the replacement tooth such that the cap cannot rotate.

In another self-cutting screw-in bone implant for dental purposes in accordance with DE 37 08 638 A1, the thread body is conical, but its thread runs cylindrically and is provided with notched edges and wedge-like notches. The thread flanks have different flank angles. Provided in the upper part of the implant base body is a female thread to which a hexagon socket is attached.

Finally, known from WO 01/21091 is a screw-shaped enossal dental implant having an apically placed implant tip, an implant neck extending in the coronal direction, and a male thread that has a largely parabolic exterior contour with the implant tip as the apical point.

Due to their geometric shape, the dental implants known from the prior art cause an unfavorable distribution of the compression forces on thejaw bone during the setting process. In order to completely alleviate their effect in the upper area, the cervical portion of the implant is kept cylindrical, whereby closure problems and thus the risk of infection can arise because of the lack of just slight compression. Furthermore, the notches are frequently dimensioned too small so that shaving removal when the implant is screwed into the bone is not satisfactory and there is no primary anti-rotational effect. Frequently the thread flanks are also dimensioned too small and as a consequence the implant does not find an adequate hold in the bone.

### SUMMARY OF THE INVENTION

The object of the invention is to create a screw-in enossal dental implant of the type cited in the foregoing that eliminates the disadvantages of the prior art and the diameter of which increases non-proportionally from the apical region to the crestal region and the lower part of which is self-centering during the screwing-in procedure and in which the compression forces acting on the jaw bone approach zero unevenly as the screw-in depth increases and a certain closure is attained in the enossal area.

In accordance with the invention, this object is attained in that:
6. the upper part is embodied cylindrical and has a polished neck segment in the coronal direction toward the thread;
7. has a groove arrangement in the crestal passage for preventing bone loss;
8. the thread arrangement on the base body is limited by parabolas P3, P4 and the thread tips by parabolas P1, P2, so that the thread arrangement from the apical to the crestal has an imperceptibly decreasing thread depth, the thread arrangement reaching to the upper part;
9. the thread flanks of the thread arrangement have a flank angle of 20 degrees;
10. the transition from the base body to the bulged enossal part is embodied rounded; and,
11. the notches each have a maximum depth of ⅓ of the diameter of the base body and a width that is at least as wide as the width of the remaining thread arrangement between the notches.

The advantages of the invention are comprised in that during the dental implant setting process the lower part causes self-centering. The distribution and effect of the lateral compression forces on the jaw bone, which naturally becomes weaker in the upward direction, adapt to these conditions and approach zero at the enossal exit, whereby secure positioning is assured and thus a secure closure is attained and infections caused by bacterial penetration are largely prevented, which has a positive effect on the healing process.

The polished neck segment in the cylindrical upper part ensures that after the implant has been set the mucous membrane is positioned thereon in the most non-irritating manner possible so that the healing process is accelerated and e.g. gingival inflammation is prevented. The modified neck segment provides a good soft tissue attachment for the gingiva.

In some known dental implants, there is an intermediate space between the upper part and the thread arrangement on the base body. In accordance with the invention this intermediate space is avoided so that the thread arrangement, with a nearly unchanged cross-sectional geometry of the thread flank, that is, without perceptible tapering, reaches directly to the upper part. The powerful thread is thus used across the entire length of the base body so that the dental implant is securely anchored in the bone, and primary stability is thus improved and the passage area of the implant remains tension-free in the bones.

The course of the parabolas on the base body and on the thread tips lends the thread systemic character, i.e. the parabola of the base body does not intersect the parabola of the thread base. This makes it possible to optimize the cutting tools for the dental implant in that universal cutters can be used with the same implant diameter. Moreover, this means the base body can be thinner.

Moreover, the dimensioning of the notches effects better insertability, optimum shaving placement, and better shaving removal when the implant is set, and certain primary and secondary anti-rotation protection. Usefully at least three notches are added from the apical to at least the fifth thread turn.

Finally, the rounded transition from the base body to the bulged enossal part reduces the risk of injury when placing the implant in the bone, especially in the area of the superior maxilla posterior tooth.

In accordance with another embodiment of the invention, the cylindrical upper part has a height of about 2 mm, the polished neck segment on the cylindrical upper part having a height of about 0.75 mm.

In accordance with another embodiment of the dental implant, provided in the center of the upper part is a cylindrical bore that has a thread beginning in the apical direction and ending in the crestal direction in a hexagon socket with a 60-degree bevel.

Moreover, embodied as the end on the upper part is a collar to which the conical part connects with preferably a hexagon socket and a bore with a thread. The conical part receives and the collar is a support for a cap that can be fixed with a fastening screw. The conical part is notched and offers anti-rotation protection for the cap to be received.

It is obvious that the aforesaid features and the features to be explained in the following can be used not only in the combinations provided but also in other combinations. The framework of the present invention is not defined solely by the claims.

### BRIEF DESCRIPTION OF THE INVENTION

The invention is explained in greater detail in the following description using exemplary embodiments that are depicted in the drawings.

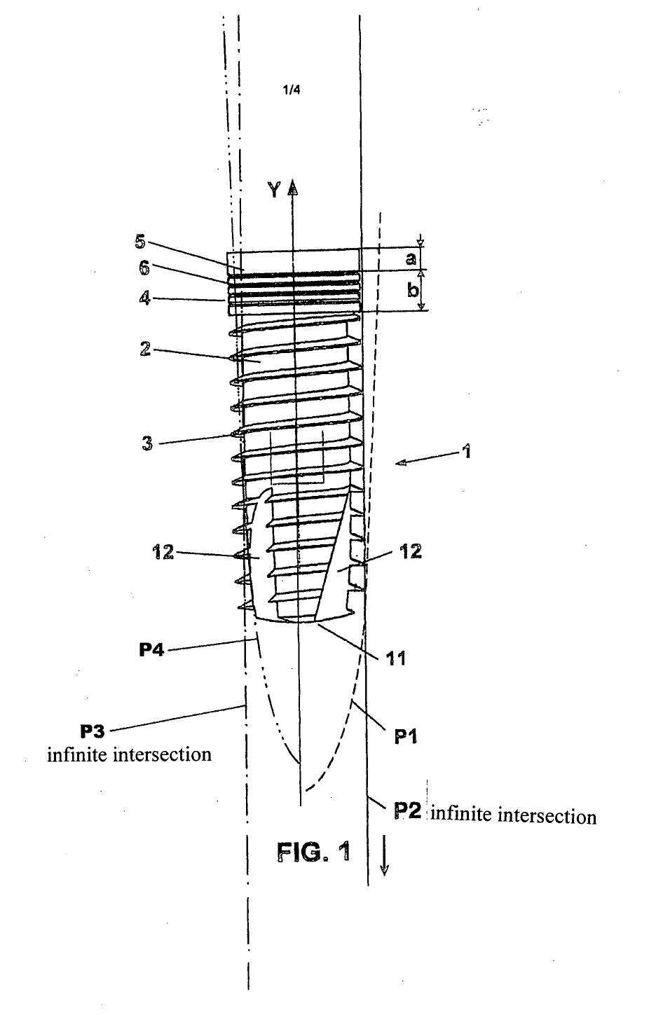

FIG. 1 is a front elevation of an inventive dental implant in accordance with a first embodiment;

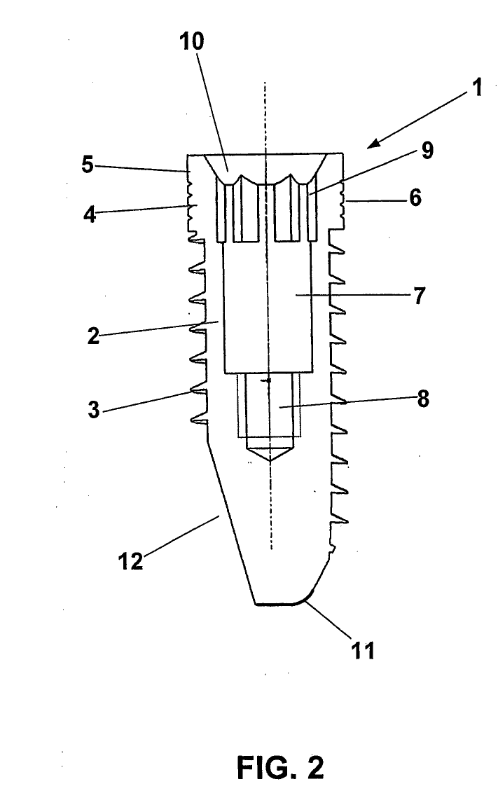

FIG. 2 is a sectional view of the dental implant in accordance with FIG. 1;

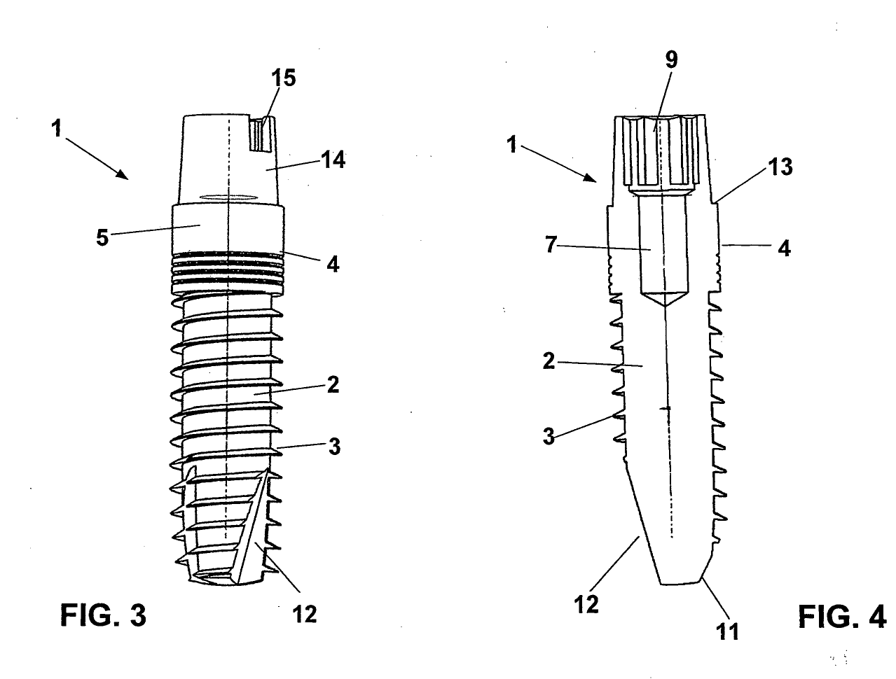

FIG. 3 is a front elevation of a dental implant in accordance with a second embodiment;

FIG. 4 is a sectional view of the dental implant in accordance with FIG. 3;

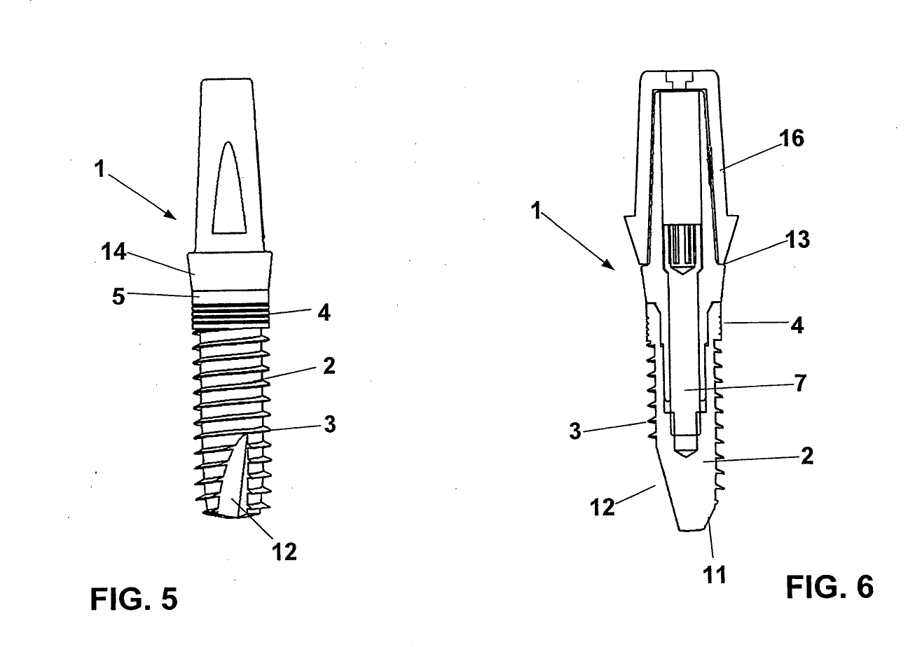

FIG. 5 is a front elevation of a dental implant in accordance with a third embodiment; and,

FIG. 6 is a sectional view of the dental implant in accordance with FIG. 5 with a cap.

### DETAILED DESCRIPTION OF THE INVENTION

The inventive dental implant 1 in accordance with FIGS. 1 through 6 comprises a base body 2 that tapers from the crestal to the apical and that is provided from the apical to the crestal with a self-cutting asymmetrical thread 3, which can also be multi-threaded, having a largely constant or imperceptibly decreasing thread depth. The thread cross-section forms a scalene triangle, the flank angle of which is 20 degrees. The thread height and thus the thread 3 are enclosed in parabolas P1, P2 and P3, P4, whose axis of symmetry is that of the base body 2 and to make this easier to visualize is the Y axis of a Cartesian coordinate system. The advantageous selection of the parabolas P3 and P4 determines the thread arrangement on the base body 2, the parabolas P1 and P2 limiting the thread tip. The parabolas P1 and P2 intersect outside of the area of the dental implant 1, as shown in FIG. 1. Thus the thread arrangement runs from the apical to the crestal. The thread 3 reaches a thread-free surface-treated upper part 4 that is attached to the base body 2 coronal to the thread arrangement.

The upper part 4 is cylindrical, that is, its shape is not adapted to the parabolas, and possesses a polished neck segment 5 facing in the coronal direction away from the thread 3. The upper part 4 has a height b of preferably 1.25 mm and the polished neck segment 5 has a height a of preferably 0.75 mm. In its height area b, the upper part 4 has a plurality of circumferential grooves 6 for protecting the corticalis in the passage area.

In accordance with FIG. 2, a cylindrical bore 7 that runs into the base body 2 and with a thread 8 that runs in the apical direction is inserted into the cylindrical upper part 4. The bore 7 is provided with a hexagon socket 9 that runs out in a bevel 10 of 60 degrees. The upper end of the upper part 4 is ground flat. This guarantees tightness between implant and structural parts. At the same time, this overall geometry enables certain adaptation of various structural parts that are secured against rotation by the hexagon socket 9 and that provide a secure force fit and positive fit connection.

At the apical end, the base body 2 transitions into a bulged enossal part 11, the transition from the base body 2 to the bulged enossal part 11 being rounded. The enossal part 11 can also be formed by an arc with a large radius or by an elliptical arc.

Three notches 12, which are advantageously offset by 120 degrees, run from the bulged enossal part 11 in the crestal direction over at least five thread turns. The notches 12 each have a maximum depth of ⅓ of the diameter of the base body 2 and a width that is at least as wide as the width of the remaining thread arrangement between the notches 12.

The base body 2 comprises titanium and is additively or subtractively machined to optimize the surface in order to attain optimum healing times.

In another exemplary embodiment in accordance with FIGS. 3 and 4, the cylindrical upper part 2 terminates in the gingival passage area with a collar 13 to which is connected in the coronal direction a conical part 14 that has approximately 6 degrees of conical inclination and that is advantageously provided with an internal hexagon socket and thread for secure fixation and holding of a cap 16 that in accordance with FIGS. 5 and 6 sits flush thereupon. In accordance with FIG. 4, the central bore 7 with the thread 8 is thus disposed in the area of the upper part 4 and conical part 14. The collar 13 is the precise terminal edge of the cap 16, which is attached to the conical part 9. The recess 15 secures the cap 16 against rotation.

In the embodiment of the dental implant in accordance with FIGS. 5 and 6, the cap 16 can be used as the primary element in a bar connection (not shown). The cap 16 can be individually shortened from the coronal area and securely fixed by being screwed on central and occlusal, e.g. by means of the fastening screw. It is primarily for prosthesis coupling in the sense of prostheses that can be removed under certain conditions that, via bars or conical connections, form a functional unit with the implants. In special situations, individual crowns, screwed on from the occlusal, can also be attached to the dental implant 1. The recess 15 secures the crown against rotation.

The inventive dental implant works as follows:

Setting occurs after the opening for the dental implant 1 to be set has been made in the jaw bone in a known manner e.g. with a dental drill. The base body 2 is screwed into the jaw opening with a guided screwdriver tool. The notches 12 located in the apical part facilitate gentle cutting and furthermore provide an anti-rotational function. The parabolic-cylindrical shape of the dental implant 1 has a centering action and presses gently into the cylindrical prepared bone bearing. Slight bone wear and simultaneous very good primary stability are the result and the requirement for good osseointegration of the dental implant 1.

The apical rounded enossal part 11 protects the maxillary sinus membrane when the dental implant 1 is used in the region of the superior maxilla posterior tooth, especially when the bone height is reduced and an indirect or direct sinus lift is required.

As a result of the parabolic course of the base body 2 in the cylindrical upper part 4, very slight compression forces in the upper area of the setting bore are adequate so that the enossal exit is closed with certainty.

The perfectly fitting illustrated conical cap 16 provided with a locking pin can also be used as a crown frame and can be coated with tooth-colored materials (plastic or ceramic).

1. Screw-in enossal dental implant, comprising a parabolic base body that has an arrangement of self-cutting threads that is provided with at least two notches, and having an upper part provided coronal to said thread arrangement with a shaped hole to assist with screwing in and a thread for attaching and fixing dental prostheses and having a bulged enossal part,
wherein
said upper part is cylindrical and has a polished neck segment in a coronal direction toward said thread and grooves that run circumferentially therebetween;
said thread arrangement on said base body is limited by parabolas and a tip of the thread by other parabolas, which intersect outside of said dental implant, so that said thread arrangement from an apical to a crestal has an imperceptibly decreasing thread depth, said thread arrangement reaching to said upper part;
flanks of said threads of said thread arrangement have a flank angle of 20 degrees;
the transition from said base body to said bulged enossal part is rounded; and,
said notches each have a maximum depth of ⅓ of the diameter of said base body and a width that is at least as wide as the width of the remaining thread arrangement between said notches.

2. Dental implant in accordance with claim 1, wherein said cylindrical upper part has a height of about 2 mm.

3. Dental implant in accordance with claim 1, wherein provided in the center of said upper part is a cylindrical bore that has a thread beginning in the apical direction and ending in the crestal direction in a hexagon socket with a 60-degree bevel and ground flat.

4. Dental implant in accordance with claim 1, wherein said polished neck segment has a height of about 0.75 mm on said cylindrical upper part.

5. Dental implant in accordance with claim 1, wherein said notches number at least three and are situated from the apical to at least the fifth thread.

6. Dental implant in accordance with claim 1, an end on said upper part is in the form of a collar.

7. Dental implant in accordance with claim 14, wherein said conical part with said hexagon socket, a recess, and threads attaches to said collar.

8. Dental implant in accordance with claim 15, wherein said conical part receives and said collar is a support for cap 16.

9. Dental implant in accordance with claim 8, wherein said cap is fixed with a fastening screw.

10. Dental implant according to claim 1, wherein the self-cutting thread arrangement is multi-threaded.

11. Dental implant according to claim 1, further comprising a conical part.

12. Dental implant according to claim 1, further comprising a cap.

13. Dental implant according to claim 6, further comprising a conical part.

14. Dental implant according to claim 6, further comprising a conical part and a cap.
